(19) United States
(12) Patent Application Publication
(10) Pub. No.: US 2024/0181282 A1
(43) Pub. Date: Jun. 6, 2024

(54) SELF-LOCKING SPRINKLER HEAD FOR SPRAYING HIGH CORROSIVE CHEMICAL LIQUID MEDIA

(71) Applicant: SAUDI ARABIAN OIL COMPANY, Dhahran (SA)

(72) Inventors: Andreas De Palmenaer, Dhahran (SA); Mohamed Bouhrara, El Jadida (MA); Turki A. Alomairi, Dhahran (SA)

(73) Assignee: SAUDI ARABIAN OIL COMPANY, Dhahran (SA)

(21) Appl. No.: 18/061,163

(22) Filed: Dec. 2, 2022

(51) Int. Cl. A62C 35/02; A62C 35/68; A62D 1/00

(52) U.S. Cl. CPC A62C 35/026; A62C 35/68; A62D 1/0035

(57) ABSTRACT

A self-locking sprinkler is disclosed. The self-locking sprinkler includes an outer body having a receiving portion positioned within an outer wall, where a fluid path is formed between the receiving portion and the outer wall, and a sprinkler diffusor threadedly connected to the receiving portion. The outer wall has an outer threaded surface configured to screw into a fluid dispensing system. The receiving portion has an inner threaded surface defining a central aperture. The sprinkler diffusor includes a blade configured to dispense the fluid, and a threaded post extending perpendicularly from the blade, where the threaded post threadably mates with the inner threaded surface. The self-locking sprinkler also includes a self-locking mechanism configured to exert a turning momentum in opposition to a rotation of the blade.

### BACKGROUND

Sprinklers have been developed and used for fire safety applications and plant watering systems for many years. Accordingly, a sprinkler system is typically designed to disperse relatively large amounts of water for putting out a fire or to water a planting area. For example, the water spray area and the water droplet size may be optimized for putting out a fire by designing a nozzle in the sprinkler to have a selected diameter, where larger nozzle diameters may provide a greater flow coefficient and sprinkle capacity.

Because sprinklers are typically used to disperse water, they are often made of a material that is resistant to corrosion from water, such as plastic or stainless steel. Sprinklers used for extinguishing a fire may further be designed to be heat resistant (to withstand temperatures generated by a surrounding fire), and thus, are often made of stainless steel.

Other sprinkler design parameters such as an upward or downward spray direction and spray area have also been optimized for extinguishing fires or watering plants.

### SUMMARY

This summary is provided to introduce a selection of concepts that are further described below in the detailed description. This summary is not intended to identify key or essential features of the claimed subject matter, nor is it intended to be used as an aid in limiting the scope of the claimed subject matter.

In one aspect, embodiments disclosed herein relate to a self-locking sprinkler. The self-locking sprinkler may include an outer body comprising a receiving portion having an inner threaded surface, an outer wall having an outer threaded surface configured to screw into a fluid dispensing system, and a fluid path formed between the receiving portion and the outer wall. The sprinkler may also include a sprinkler diffusor threadably connected to the receiving portion via the inner threaded surface, the sprinkler diffusor comprising a blade configured to dispense the fluid and a threaded post extending perpendicularly from the blade and threadably mated with the inner threaded surface, wherein at least a portion of the blade is sloped in an orientation corresponding with the inner threaded surface.

In another aspect, embodiments disclosed herein relate to a self-locking sprinkler system. The self-locking sprinkler system may include a sprinkler head, comprising an outer body having an outer wall with an outer threaded surface, a receiving portion having an inner threaded surface defining a central aperture, wherein the receiving portion is positioned centrally within and connected to the outer wall via ribs, and fluid paths formed between the outer wall and the receiving portion and between the ribs. The sprinkler head may further include a sprinkler diffusor threadably connected to the inner threaded surface, where the sprinkler dispenser may include a blade configured to dispense the fluid, and a threaded post extending perpendicularly from the blade and configured to threadably mate with the inner threaded surface, wherein the blade comprises a sloped surface sloping in the same direction as the inner threaded surface. The self-locking sprinkler system may also include a fluid dispensing system threadably connected to the upper body portion via the outer threaded surface.

In yet another aspect, embodiments disclosed herein relate to a method. The method may include providing a fluid dispensing system, screwing a self-locking sprinkler into a connection joint of the fluid dispensing system, and introducing a fluid to the self-locking sprinkler via the connection joint. The self-locking sprinkler may include an outer body comprising a receiving portion having an inner threaded surface, an outer wall having an outer threaded surface, and a fluid path formed between the receiving portion and the outer wall. The self-locking sprinkler may also include a sprinkler diffusor threadably connected to the inner threaded surface, the sprinkler diffusor comprising a blade configured to dispense the fluid, and a threaded post extending perpendicularly from the blade and configured to threadably mate with the inner threaded surface. The method may also include spraying the fluid out of the self-locking sprinkler, and exerting a turning momentum in a direction of the outer body and the threaded post, where the turning momentum is created, at least in part, by spraying the fluid.

Other aspects and advantages of the claimed subject matter will be apparent from the following description and the appended claims.

### BRIEF DESCRIPTION OF DRAWINGS

Specific embodiments of the disclosed technology will now be described in detail with reference to the accompanying figures. Like elements in the various figures are denoted by like reference numerals for consistency. The size and relative positions of elements in the drawings are not necessarily drawn to scale. For example, the shapes of various elements and angles are not necessarily drawn to scale, and some of these elements may be arbitrarily enlarged and positioned to improve drawing legibility. Further, the particular shapes of the elements as drawn are not necessarily intended to convey any information regarding the actual shape of the particular elements and have been solely selected for ease of recognition in the drawing.

FIG. 1A-1E shows a self-locking sprinkler in accordance with one or more embodiments.

FIGS. 2A and 2B show a fluid dispensing system coupled to one or more self-locking sprinklers in accordance with one or more embodiments.

FIGS. 3A and 3B show a blade of a self-locking sprinkler in accordance with one or more embodiments.

FIG. 4 shows a blade of a self-locking sprinkler in accordance with one or more embodiments.

FIG. 5 shows a flowchart of a method in accordance with one or more embodiments.

### DETAILED DESCRIPTION

In the following detailed description of embodiments of the disclosure, numerous specific details are set forth in order to provide a more thorough understanding of the disclosure. However, it will be apparent to one of ordinary skill in the art that the disclosure may be practiced without these specific details. In other instances, well-known features have not been described in detail to avoid unnecessarily complicating the description.

Throughout the application, ordinal numbers (e.g., first, second, third, etc.) may be used as an adjective for an element (i.e., any noun in the application). The use of ordinal numbers is not to imply or create any particular ordering of the elements nor to limit any element to being only a single element unless expressly disclosed, such as using the terms “before”, “after”, “single”, and other such terminology. Rather, the use of ordinal numbers is to distinguish between the elements. By way of an example, a first element is distinct from a second element, and the first element may encompass more than one element and succeed (or precede) the second element in an ordering of elements.

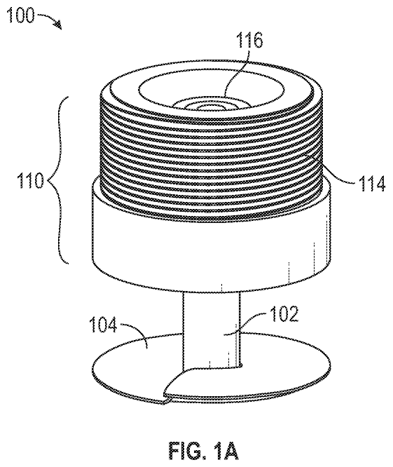

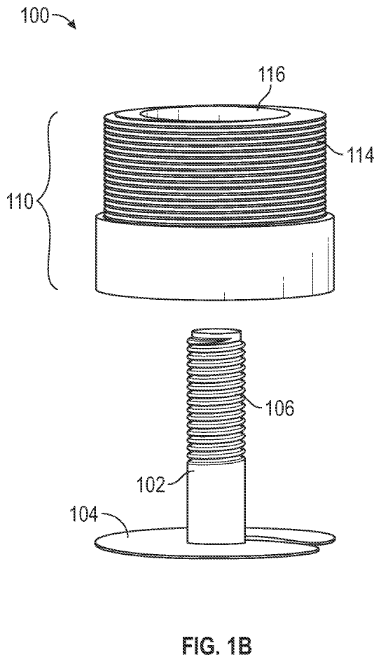

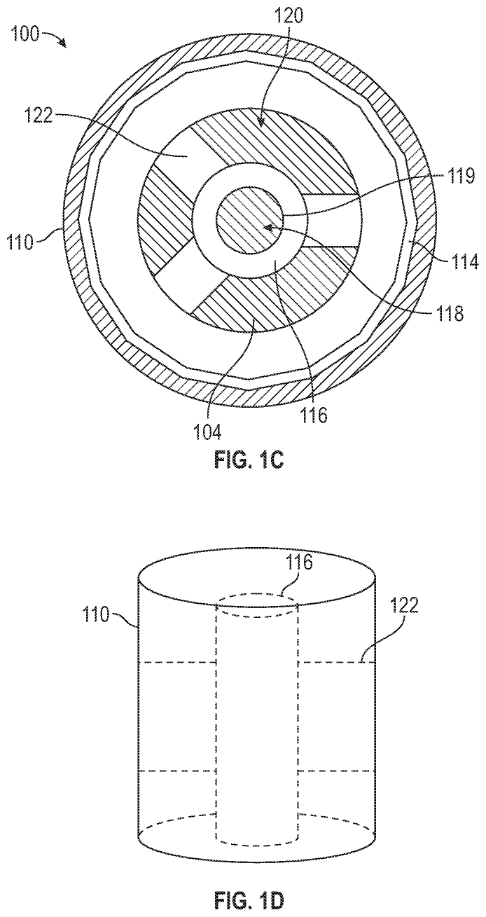

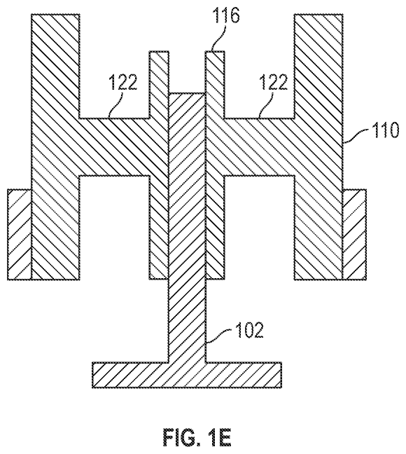

In the following description of FIGS. 1-5, any component described with regard to a figure, in various embodiments disclosed herein, may be equivalent to one or more like-named components described with regard to any other figure. For brevity, descriptions of these components may not be repeated for each figure. Thus, each and every embodiment of the components of each figure is incorporated by reference and assumed to be optionally present within every other figure having one or more like-named components. Additionally, in accordance with various embodiments disclosed herein, any description of the components of a figure is to be interpreted as an optional embodiment which may be implemented in addition to, in conjunction with, or in place of the embodiments described with regard to a corresponding like-named component in any other figure.

In one aspect, embodiments disclosed herein relate to a self-locking sprinkler head configured to counter-act a right turning momentum generated by the movement of the sprinkler components when dispensing a fluid. In another aspect, embodiments disclosed herein relate to a self-locking sprinkler head designed to dispense highly corrosive fluids and fluids at very high temperatures without reducing the usable life of the sprinkler head. In yet another aspect, embodiments disclosed herein relate to a method of dispensing highly corrosive fluids and/or fluids at very high temperatures through a self-locking sprinkler head system.

Turning first to FIGS. 1A-1E, FIG. 1A shows a side view of a self-locking sprinkler head 100, FIG. 1B shows an exploded view of the self-locking sprinkler head 100, FIG. 1C shows a top view of the self-locking sprinkler head 100, FIG. 1D shows a schematic diagram of the internal structure of a body portion of the sprinkler head 100, and FIG. 1E shows a cross-sectional view of the sprinkler head 100 in accordance with one or more embodiments. In one or more embodiments, the self-locking sprinkler head 100 may have a sprinkler diffusor 102. The sprinkler diffusor 102 may be composed of at least one blade 104 and a threaded post 106 which may extend from a center of the blade(s) 104 in a perpendicular direction.

In one or more embodiments, the threaded post 106 may be configured to threadably mate with an outer body 110 via a central receiving portion 116. In one or more embodiments, the outer body 110 may have an inner threaded surface 119 formed in the central receiving portion 116 and an outer threaded surface 114 formed around the outer circumference of an upper axial end of the outer body 110. The central receiving portion 116 may be located centrally in the outer body 110, where the threaded post 106 may threadably mate with the inner threaded surface 119 in the central receiving portion 116. In one or more embodiments, the receiving portion 116 may be integrally formed with the outer body 110. In other embodiments, the receiving portion 116 may be removably and adjustably fixed to the outer body 110.

In one or more embodiments, as shown in FIG. 1C, the receiving portion 116 may have a central aperture 118 formed therethrough and defined between the inner threaded surface 119 of the receiving portion 116, where the threaded post 106 of the of the sprinkler diffusor 102 may be inserted into a bottom end of the central aperture 118 and threadably connected to the inner threaded surface 119. In other words, the central aperture 118 may extend through a length of the outer body 110, creating a receiving slot into which the threaded post 106 may thread. In one or more embodiments, one end of the threaded post 106 may mate with the inner threaded surface 119 of the central aperture 118.

The receiving portion 116 may be centrally held within the outer body 110 via two or more ribs 122. In one or more embodiments, the ribs 122 may be integrally formed with the receiving portion 116. The ribs 122 may extend from the receiving portion 116 to the outer body 110, such that fluid paths 120 are formed between the ribs 122. In some embodiments, there may be three ribs 122 extending from the receiving portion 116 to the outer wall of the outer body 110, each rib 122 angled 1200 from the adjacent ribs 122. Additionally, ribs 122 may extend between the receiving portion 116 and the outer body 110 at a single axial position, as shown in FIG. 1E for example, or at multiple axial positions. In one or more embodiments, the ribs 122 may be fixed perpendicular to the receiving portion 116. In other embodiments, the ribs 122 may extend away from the receiving portion 116 at an angle.

Fluid being dispensed through the sprinkler 100 may flow through the fluid paths 120 to land on the blades 104 of the sprinkler diffusor 102, and thereby dispensing the fluid from the sprinkler 100. According to embodiments of the present disclosure, the blade(s) 104 may have a sloped surface sloping in the same direction as the inner threaded surface 119 of the receiving portion 116. For example, viewing the sprinkler from a top end, as shown in FIG. 1C, when the inner threaded surface 119 slopes downwardly in a clockwise direction, the blade(s) 104 may have one or more sloped surfaces positioned in line with the fluid paths 120 that slope in the same direction as the inner threaded surface 119. Conversely, when the inner threaded surface 119 slopes downwardly in a counter-clockwise direction, the blade(s) 104 may have a sloped surface that slopes downwardly in a counter-clockwise direction. By providing one or more blades of a sprinkler with at least a portion of the blade sloped in an orientation corresponding with the inner threaded surface, the force of fluid hitting the sloped portions may push the blade(s) in a turning momentum that corresponds with the threading direction of the threaded connection between the sprinkler diffusor 102 and the receiving portion 116, thereby providing a self-locking mechanism to keep the sprinkler diffusor 102 threadedly connected to the receiving portion 116 during operation of the sprinkler.

Similarly, according to embodiments of the present disclosure, the blade(s) 104 may have a sloped surface sloping in the same direction as the outer threaded surface 114. In some embodiments, blade(s) may have a sloped surface sloping in the same direction as both the outer threaded surface 114 and the inner threaded surface 119 of the receiving portion 116. By providing one or more blades of a sprinkler with at least a portion of the blade sloped in an orientation corresponding with the outer threaded surface, the force of fluid hitting the sloped portions may push the blade(s) in a turning momentum that corresponds with the threading direction of the threaded connection between the sprinkler outer body and a fluid dispensing system in which the sprinkler is connected, thereby providing a self-locking mechanism to keep the sprinkler threadedly connected to the fluid dispensing system during operation of the sprinkler.

In one or more embodiments, the outer body 110 and the sprinkler diffusor 102 may be composed of a high thermal and corrosive resistant material, such as a perfluoroalkoxy alkane (PFA), a polytetrafluoroethylene (PTFE), an ethylene chlorotrifluoroethylene (ECTFE), a polyvinylidene fluorides (PVDF), or a corrosion resistant steel.

In one or more embodiments, the self-locking sprinkler 100 may be configured to dispense the fluid via spraying techniques, sprinkling techniques, or aerosol techniques. Further, the self-locking sprinkler may be configured to maximize generation of fine aerosol droplets from a precursor solution for use in one or more thermo-chemical functionalization processes.

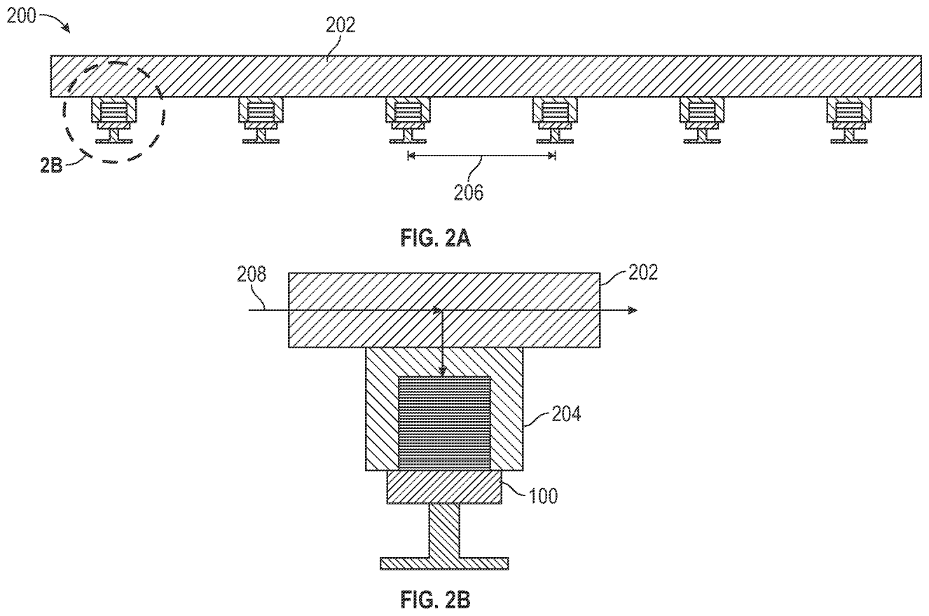

Turning now to FIGS. 2A and 2B, FIGS. 2A and 2B show a fluid dispensing system 200 coupled with one or more self-locking sprinklers 100 in accordance with one or more embodiments. As shown in FIG. 2A, a feedstock pipe 202 may serve as a fluid inlet for each self-locking sprinkler 100. The feedstock pipe 202 may have one or more connection joints 204 integrally formed along a lower side of the pipe. In one or more embodiments, each connection joint 204 may be spaced from adjacent connection joints 204 by a distance 206. In one or more embodiments, the distance 206 may range from 5 cm to 50 cm. The distance between connection joints 204 and the distance between self-locking sprinklers 100 may be used interchangeably. In one or more embodiments, each connection joint 204 may have a hollow interior and internal threads disposed around its interior.

FIG. 2B shows, in detail, the connection between the self-locking sprinkler 100 and a connection joint 204 of the fluid dispensing system 200. In one or more embodiments, the upper body portion 112 may screw into the hollow interior of the connection joint 204, mating the outer threaded surface 114 and the internal threads of the connection joint 204.

Fluid 208 may flow through the feedstock pipe 202 and the connection joint 204, where it may be received by the outer body 110 of the self-locking sprinkler 100. In one or more embodiments, the fluid 208 may be a precursor solution, which could include a pure organic solvent, an inorganic solvent, a catalyst, or an active reagent. Further, the fluid 208 may be heated to temperatures up to 400° C.

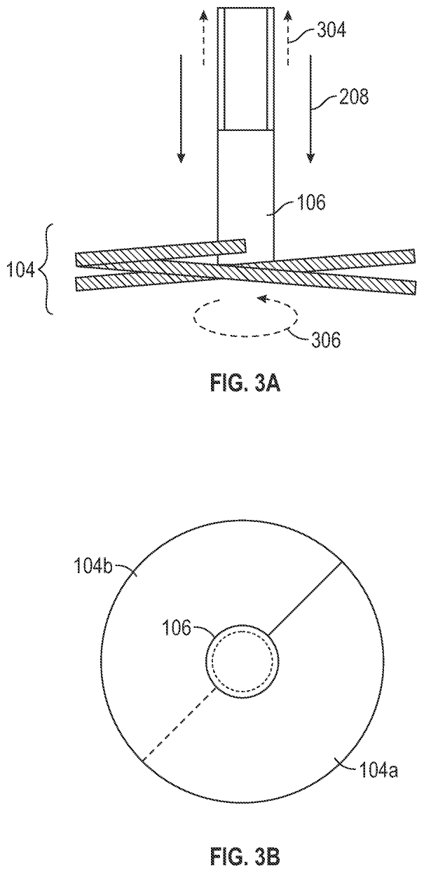

FIGS. 3A and 3B show a blade 104 of a self-locking sprinkler 100 in accordance with one or more embodiments. In one or more embodiments, the blade 104 may include a plurality of members 104a, 104b positioned in a spiral configuration about the central post 106. More specifically, the plurality of members 302 may be arranged in a circle such that one of the members 104a overlaps another of the members 104b.

In one or more embodiments, fluid 208 may flow in a downward direction from the outer body 110, through the fluid paths 120, towards the blade 104. In one or more embodiments, the blade 104 may rotate in order to dispense the fluid 208. As the blade 104 dispenses the fluid 208, the sprinkler diffusor may move in an upwards direction 304, in opposition to the fluid 208 flow direction. A tightening turning momentum 306 may be applied by the force (magnitude and direction) of the fluid contacting the blades 104, which may prevent loosening in the connection between the threaded post 106 with the self-locking sprinkler 100.

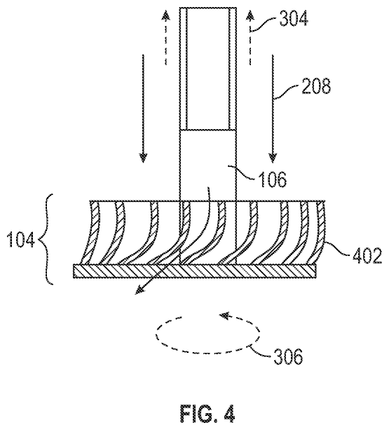

FIG. 4 shows a blade 104 of a self-locking sprinkler 100 in accordance with one or more embodiments. In one or more embodiments, the blade 104 may include a plurality of members 402 fanning radially around a center of the blade 104. In one or more embodiments, each of plurality of members 402 may be curved, with each member 402 arranged radially around the center of the blade 104 in the same manner as the blades in a fan or turbine. Movement of fluid 208 through the fluid paths 120 and through the blade 104 may result in a stronger tightening turning momentum 306. Further, use of a blade 104 with such a configuration of members 402 may improve sprinkler effectiveness as fluid 208 may be better dispersed into the room or chamber below.

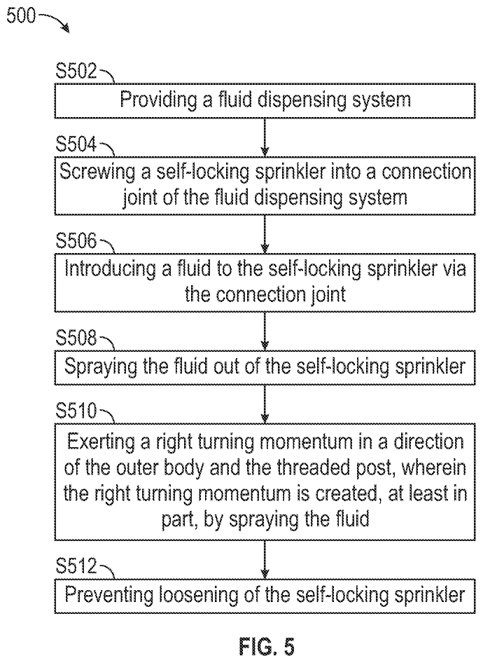

FIG. 5 depicts a flowchart in accordance with one or more embodiments. More specifically, FIG. 5 depicts a flowchart 500 of a method of dispensing a chemical fluid using a sprinkler according to embodiments of the present disclosure. Further, one or more blocks in FIG. 5 may be performed by one or more components as described in FIGS. 1-4B. While the various blocks in FIG. 5 are presented and described sequentially, one of ordinary skill in the art will appreciate that some or all of the blocks may be executed in different orders, may be combined, may be omitted, and some or all of the blocks may be executed in parallel. Furthermore, the blocks may be performed actively or passively.

Initially, a fluid dispensing system 200 may be provided, S502. In one or more embodiments, the fluid dispensing system 200 may include a feedstock pipe 202 and one or more connection joints 204. In some embodiments, the feedstock pipe 202 may be provided in a reaction chamber, where fluid being delivered from the feedstock pipe 202 may include chemical solutions for use in the reaction chamber. Next, a self-locking sprinkler 100 may be screwed into one of the connection joints 204, S504. In one or more embodiments, step S504 may be repeated for a number of additional self-locking sprinklers 100 as required.

A fluid 208 may be introduced to the self-locking sprinkler 100 via the connection joint 204, S506. In one or more embodiments, the fluid 208 may be a precursor solution, which could include a pure organic solvent, an inorganic solvent, a catalyst, or an active reagent. Further, the fluid 208 may be heated to temperatures up to 400° C.

The fluid 208 may be sprayed out of the self-locking sprinkler 100, S508. Specifically, fluid may be dispersed via splashing of fluid 208 against the blade 104. In some embodiments, fluid 208 may also be dispersed via rotation of the blade 104. In one or more embodiments, splashing fluid 208 against the blade 104 may create a tightening turning momentum 306. The fluid 208 pressure may be higher than atmospheric pressure such that fluid may be sprinkled into the room or chamber below. In one or more embodiments, spraying the fluid comprises converting the fluid into a plurality of fine aerosol droplets. However, spraying the fluid 208 may include spraying techniques and sprinkling techniques in addition to aerosol techniques. Spraying the fluid 208 may allow a large surface area to be reached,

A tightening turning momentum 306 may be exerted on the sprinkler diffusor 102 in the direction of the threads between the upper body portion 112 and the threaded post 106, which may move the blades 104 in an axial direction toward the upper body portion 112 of the sprinkler, S510. For example, when the threaded post 106 is screwed into the upper body portion 112 via a righthand turn, the blades 104 of the sprinkler diffusor 102 may be designed to exert a right-handed tightening turning momentum 306 when dispensed fluid impinges on the blades 104. In one or more embodiments, the tightening turning momentum 306 is created by spraying the fluid 208. The blade 104 may redirect the falling force of the fluid 208 in a circumferential direction. For example, embodiments of a blade 104 in accordance with FIGS. 3A and 3B may act similar to a thread. Further, embodiments of a blade 104 in accordance with FIG. 4 may act like a radial turbine. Deflection of the fluid 208 force in a circumferential direction may generate the tightening turning momentum 306. In one or more embodiments, the tightening turning momentum 306 may also exert a steady force which may fix the self-locking sprinkler 100 in the connection joint 204. As such, loosening of the self-locking sprinkler 100 is prevented, S512. In one or more embodiments, the method depicted in flowchart 500 may be repeated for each self-locking sprinkler 100 which is connected to the fluid dispensing system 200.

Methods of using sprinklers according to embodiments of the present disclosure may be used in thermo-chemical functionalization processes. For example, methods disclosed herein for dispensing chemical fluids using sprinklers according to embodiments of the present disclosure may be used for carbon fiber manufacturing. In such methods, a sprinkler according to embodiments of the present disclosure may be used to spray, sprinkle, or dispense aerosol droplets of highly corrosive chemical fluids at high temperatures, such as highly concentrated (e.g., 95% by volume or more) sulfuric acid at 110-130° C. (e.g., 120° C.), for production of carbon fibers. Methods of using sprinklers according to embodiments of the present disclosure may also be used to disperse other corrosive chemical fluids, such as acidic fluids having a pH of less than 4.

Embodiments of the present disclosure may provide at least one of the following advantages. Present commercially available sprinkler heads are incapable of withstanding continued exposure to precursor solutions which are highly corrosive or at very high temperatures. Embodiments of the present disclosure allow for prolonged spraying of highly corrosive precursor solutions heated to very high temperatures. Further, in prolonged spraying operations, the dispensing motion of the sprinkler head may cause loosening of the sprinkler within the fluid dispensing system. Embodiments of the present disclosure include a self-locking mechanism which may exert a right turning momentum to counteract any loosening of the sprinkler.

Although only a few example embodiments have been described in detail above, those skilled in the art will readily appreciate that many modifications are possible in the example embodiments without materially departing from this invention. Accordingly, all such modifications are intended to be included within the scope of this disclosure as defined in the following claims.

What is claimed:

1. A self-locking sprinkler, comprising:
an outer body, comprising:
a receiving portion having an inner threaded surface;
an outer wall having an outer threaded surface configured to screw into a fluid dispensing system; and
a fluid path formed between the receiving portion and the outer wall; and
a sprinkler diffusor threadably connected to the receiving portion via the inner threaded surface, the sprinkler diffusor comprising:
a blade configured to dispense a fluid; and
a threaded post extending perpendicularly from the blade and threadably mated with the inner threaded surface,
wherein at least a portion of the blade is sloped in an orientation corresponding with the inner threaded surface.

2. The self-locking sprinkler of claim 1, further comprising a plurality of ribs extending between the receiving portion and the outer wall, wherein the fluid path is also formed between the plurality of ribs.

3. The self-locking sprinkler of claim 1, wherein the outer body and the sprinkler diffusor are composed of a high thermal and corrosive resistant material selected from a group consisting of perfluoroalkoxy alkanes (PFAs), polytetrafluoroethylenes (PTFEs), ethylene chlorotrifluoroethylenes (ECTFEs), polyvinylidene fluorides (PVDFs), and corrosion resistant steel.

4. The self-locking sprinkler of claim 1, wherein the fluid dispensing system comprises a precursor solution selected from a group consisting of a pure organic solvent, an inorganic solvent, a catalyst, and an active reagent.

5. The self-locking sprinkler of claim 1, wherein the fluid dispensing system comprises fluid heated to temperatures up to 400° C.

6. The self-locking sprinkler of claim 1, wherein the blade comprises a plurality of members positioned in a spiral configuration about a center of the blade, and wherein the spiral configuration is sloped in the orientation corresponding with the inner threaded surface.

7. The self-locking sprinkler of claim 1, wherein the blade comprises a plurality of members fanning radially around a center of the blade, and wherein the plurality of members are sloped in the orientation corresponding with the inner threaded surface.

8. A self-locking sprinkler system, comprising:
a sprinkler head, comprising:
an outer body, comprising:
an outer wall having an outer threaded surface;
a receiving portion having an inner threaded surface defining a central aperture, wherein the receiving portion is positioned centrally within and connected to the outer wall via ribs; and
fluid paths formed between the outer wall and the receiving portion and between the ribs;
a sprinkler diffusor threadably connected to the receiving portion, the sprinkler diffusor comprising:
a blade configured to dispense a fluid, and
a threaded post extending perpendicularly from the blade and configured to threadably mate with the inner threaded surface;
wherein the blade comprises a sloped surface sloping in a same direction as the inner threaded surface; and
a fluid dispensing system threadably connected to the outer body via the outer threaded surface.

9. The self-locking sprinkler system of claim 8, wherein the sprinkler head is configured to dispense the fluid via spraying techniques, sprinkling techniques, or aerosol techniques.

10. The self-locking sprinkler system of claim 8, wherein the self-locking sprinkler system is configured to maximize generation of fine aerosol droplets from a precursor solution for use in one or more thermo-chemical functionalization processes.

11. The self-locking sprinkler system of claim 8, wherein the fluid dispensing system comprises a feedstock pipe and one or more connection joints, each connection joint being internally threaded.

12. The self-locking sprinkler system of claim 11, further comprising one or more additional sprinkler heads, each configured to screw into one of the one or more connection joints.

13. The self-locking sprinkler system of claim 12, where each of the one or more additional sprinkler heads is spaced a distance from adjacent sprinkler heads.

14. The self-locking sprinkler system of claim 13, wherein the distance ranges from 5 cm to 50 cm.

15. The self-locking sprinkler system of claim 8, wherein the blade comprises a plurality of members positioned in a spiral configuration about a center of the blade.

16. The self-locking sprinkler system of claim 8, wherein the blade comprises a plurality of members fanning radially around a center of the blade.

17. A method, comprising:
providing a fluid dispensing system;
screwing a self-locking sprinkler into a connection joint of the fluid dispensing system;
introducing a fluid to the self-locking sprinkler via the connection joint, wherein the self-locking sprinkler comprises:
an outer body, comprising:
a receiving portion having an inner threaded surface;
an outer wall having an outer threaded surface; and
a fluid path formed between the receiving portion and the outer wall; a sprinkler diffusor threadably connected to the inner threaded surface, the sprinkler diffusor comprising:
a blade configured to dispense the fluid, and
a threaded post extending perpendicularly from the blade and threadably mated with the inner threaded surface; and
spraying the fluid out of the self-locking sprinkler; and
exerting a turning momentum in a direction of the outer body and the threaded post, where the turning momentum is created, at least in part, by spraying the fluid

18. The method of claim 17, wherein spraying the fluid comprises converting the fluid into a plurality of fine aerosol droplets.

19. The method of claim 17, wherein the fluid dispensing system comprises a feedstock pipe.

20. The method of claim 17, further comprising repeating the method for one or more additional self-locking sprinkler, each self-locking sprinkler being spaced a distance away from adjacent self-locking sprinklers.
